(19) United States
(12) Patent Application Publication
(10) Pub. No.: US 2004/0255705 A1
(43) Pub. Date: Dec. 23, 2004

(54) Machine for positioning a tooling plate with an integrated linear actuator.

(76) Inventor: Denis Albert Sullivan, Portland, OR (US)

Correspondence Address: Denis A. Sullivan, 20925 NW Nolana Court, Portland, OR, 97229

(21) Appl. No.: 10/710,081

(22) Filed: Jun. 17, 2004

Related U.S. Application Data
(60) Provisional application No. 60/479,518, filed on Jun. 19, 2003.

(51) Int. Cl. H02K 41/00

(52) U.S. Cl. 74/89.33

(57) ABSTRACT

A machine for positioning a tooling plate with an integrated linear actuator, a complete, integrated slide assembly which uses standard linear actuators, an integrated bearing, shafting and tooling plate system that requires no alignment or adjustments during installation and normal use, an anodized bearing body and tooling plate with multiple drilled and tapped and counter sunk through hole mounting features with dowel slip fit holes for precision mounting and alignment, a slide body with mounting features that enable to the unit to be mounted on any of four precision machined surfaces allowing for maximum flexibility for harnessing runs to the integrated drive/controller mounting system, a plane bearing and cantilevered shaft system that requires no lubrication or maintenance, an embedded proximity switch for homing with a machined cable run protecting the cable during assembly and use. A preferred embodiment includes an integrated sheet metal mounting system for programmable drive/controllers that does not interfere with lead screw or tooling plate motion and allows the drive/controller to be replaced without replacing the actuator, an integrated mounting system that allows encoders and antibacklash nuts to be mounted on the rear of the linear actuator without interference or assembly issues. A drive/controller mount featuring a molded rubber or adhesive backed silicon rubber or engineered plastic antivibration dampening material.

### CROSS REFERENCE TO RELATED APPLICATIONS

This is a continuation in part of Application No.: 60/479,518, filed Jun. 19, 2003. Title: Machine for positioning a tooling plate or linear bearing supported slide assembly with an integrated non-captive linear actuator or external lead screw motor.

### BACKGROUND OF INVENTION

This invention relates generally to the field of motion control positioning systems and more particularly to a machine for positioning a tooling plate with an integrated linear step or servo actuator, hereafter, referred to as a linear actuator.

Linear actuators, also known as, non-captive linear actuators are integrated positioning systems that combine a step or servo motor with a lead or ball screw in a single package. Hereafter, the term linear actuator also refers to designs featuring either lead or ball screws. Commercially available linear actuators feature a nut that is embedded into the center of the motor's rotor or directly coupled to a tubular extension from the rotor. Given a through hole motor design, the screw is run through the center of the motor, engages the rotor coupled nut and exits the opposite end of the motor. The end of the screw has machined or threaded features that facilitate a fixed, non-rotational, attachment to a load. This invention uses a threaded journal at the end of the screw which engages a drilled and tapped hole in the rear of the tooling plate. By fixing the motor to a mount and the end of the screw to the tooling plate, the screw is unable to rotate; Consequently, rotational motion at the rotor and nut is transmitted into linear motion as the mating lead or ball screw threads engage the rotating nut.

Can-stack, hybrid step motor and servo linear actuators in a variety of sizes ranging from 0.75 to 4.25 inches in diameter are used widely in OEM applications; But there are no integrated, general purpose, packaged slide systems available that take advantage of these economical linear actuators. Each OEM and Factory Automation application requires a costly ground up design effort. For clarification, packaged slide systems are positioning solutions that include the motor, screw, radial and linear bearing systems and an integrated mounting system for all elements of the design. This invention is the first such packaged solution designed specifically for commercially available linear actuators.

The motion market has a large number of linear slide and stage manufacturers featuring direct drive, gear or belt driven lead or ball screws. These designs feature step and servo motors with standard motor output shafts. The motor's shaft engages a flexible coupler on one end while a lead or ball screw journal enters the opposite end. Set screws on both ends of the coupler enables motor shaft rotation to be transmitted through the rotating screw and converted to linear thrust through a fixed nut that is attached to the moving load carriage. This common design requires the near end of the screw to be supported, in general, by an angular contact bearing system providing both radial and thrust support with the far end of the screw engaging a radial bearing. The system design is significant because of the additional bearings, machined bearing housings, mounts, coupler and a full-length machined mounting system with additional length to accomodate the additional components. Alignment during assembly and surface preparation during field installation is critical or the system will suffer binding or premature bearing failures. With angular contact, radial and full travel length linear bearing systems requiring precision mounting and alignment; Slides designed for 5-10 lbs loads feature bearing and mechanical systems equally suited for 50-350 lb loads. This dramatic, design over-kill and the associated higher costs are the rule rather than the exception.

Another readily available design evolved in the fluid power market and shares a similar bearing and dual cantilevered shaft design. In simple, down and back, fluid power designs, air or hydraulic cylinders are used to thrust the tooling plate in and away from the bearing housing. More precise pneumatic cylinders featuring proportional valves and adjustable end of travel damping mechanisms have improved the state of the art but these designs lack the programmability and functionally rich utility of a linear actuator based system using a micro stepping or servo amplifier with a programmable motion controller.

More recently, fluid power manufacturers have added servo and step motor driven versions of their earlier cantilevered air cylinder driven guide systems by attaching electric cylinders, also known as, motor driven telescoping, tubular actuators, to their bearing guides. Electric cylinders are a derivative of standard slides and stages featuring an inner tubular drive assembly containing the near and far bearing system, screw, nut with a nonrotational feature and an outer, tubular assembly which is attached to and driven by the moving nut. These tubular actuator designs have a high part count and they are complex as well as costly to manufacture.

In summary, the market is served by a myriad of standard slide and stage designs and a smaller number of cantilevered tube-in-a-tube slide designs but these designs have significant design, complexity, length overhead, maintenance, assembly and installation issues that add significantly to their total system costs.

### SUMMARY OF INVENTION

The primary object of the invention is to provide a linear slide featuring integrated bearings, cantilevered shafts and a precision tooling plate system for industry standard linear actuators. The invention outlined here features a single moving element: A screw with a threaded end journal that mates with a tooling plate. The linear actuator's bearing system is the motor's bearing system and the only external components are four fasteners to attach the linear actuator to the housing. There are no other housings, machined assemblies, machined tubes or precision bases to drive up system costs, weight and total system length.

Another object of the invention is to provide a linear slide featuring extremely low particulate emissions for use in medical device and semiconductor processing clean room applications as easily and with the same cost effectiveness as general purpose positioning applications.

Another object of the invention is to provide a linear slide that provides non-lubricated linear plane bearings and ceramic coated RC70 shafting for zero maintenance applications.

A further object of the invention is to provide a linear slide with an embedded proximity switch with a machined cable run which protects the cable during assembly and use.

Yet another object of the invention is to provide a convenient and safe integrated drive/controller mount that allows an embedded drive/controller to mount between the linear actuator and linear slide assembly without interfering with lead screw or tooling plate travel. A further object of the invention is to insure the drive/controller mount allows quick assembly and service without replacing the entire actuator or detaching the load from the screw.

A further object of the invention is to use the drive/controller mount as a vibration dampener between the linear actuator and the slide housing.

Further objects and advantages of the present invention will become apparent from the following descriptions, taken in connection with the accompanying drawings, wherein, by way of illustration and example, an embodiment of the present invention is disclosed.

A machine for positioning a tooling plate with an integrated linear actuator, comprising: a complete, integrated slide assembly which uses standard linear actuators, an integrated bearing, shafting and tooling plate system that requires no alignment or adjustments during assembly and normal use, an anodized bearing body and tooling plate with multiple drilled and tapped and counter sunk through hole mounting features with dowel slip fit holes for precision mounting and alignment, a slide/bearing body with mounting features that enable to the unit to be mounted on any of four precision machined surfaces allowing for maximum flexibility for harnessing runs to the integrated drive/controller mounting system, a plane bearing and cantilevered shaft system that requires no lubrication or maintenance, an embedded proximity switch for homing with a machined cable run protecting the cable during assembly and use and a drive/controller mounting system with a vibration dampening feature. The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF DRAWINGS

FIG. 1 illustrates an exploded perspective view of a linear actuator, drive/control mount, slide body, shafts and tooling plate.

FIG. 2 illustrates an assembled perspective view of the invention.

FIG. 3 illustrates an exploded side view of the system illustrating the drive/controller mount's relative position and mounting features.

FIG. 4 illustrates the dampening material attached and/or molded to the mounting face of drive/controller mount.

### DETAILED DESCRIPTION

Detailed descriptions of the preferred embodiment are provided herein. It is to be understood, however, that the present invention may be embodied in various forms.

Therefore, specific details disclosed herein are not to be interpreted as limiting, but rather as a basis for the claims and as a representative basis for teaching one skilled in the art to employ the present invention in virtually any appropriately detailed system, structure or manner.

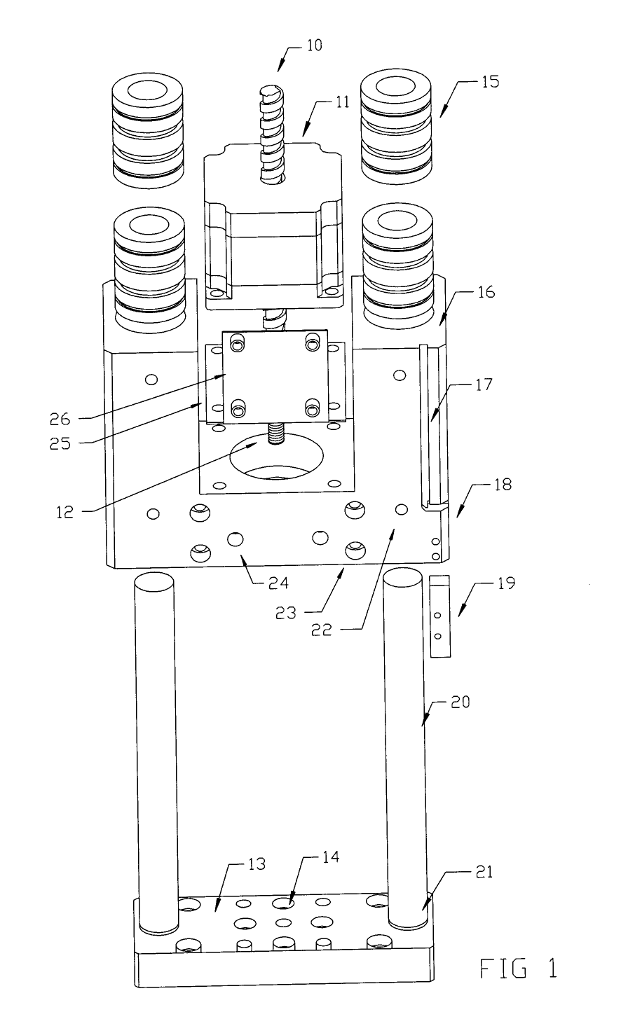

Turning first to FIG. 1 there is shown a vertical representation of the invention. A lead screw 10 is shown entering the motor 11. The journal end of the lead screw 12 is threaded such that it can screw into the rear of the tooling plate 13 at a center of mass drilled and tapped hole 14.

The four bearings 15 are slip fit into the slide body 16 and fixed in place with an adhesive. The slide body has numerous features including a machined cable run channel 17 in line with a larger machined channel 18 used to embed the proximity switch 19. The proximity sensor's cable is run through a full length channel 17 protecting the cable during during field installation. The ceramic coated, RC70 or precision ground 303 stainless shafts 20 are slip fit into the rear of the tooling plate at 21 attached to the tooling plate with stainless steel hardware.

Mounting to an application is accomplished using four through drilled and tapped holes 22 that are provided on all four machined surfaces or the four drilled and counter bored holes at 23 allowing top or bottom surface mounting to a threaded plate. Two precision slip fit dowel holes 24 are provided on each of the four mounting surfaces for precision alignment with the load and added strength. The drive/controller sheet metal L bracket has linear actuator mounting features on the right angle member 25 and drive/controller mounting stand-offs on the top surface 26.

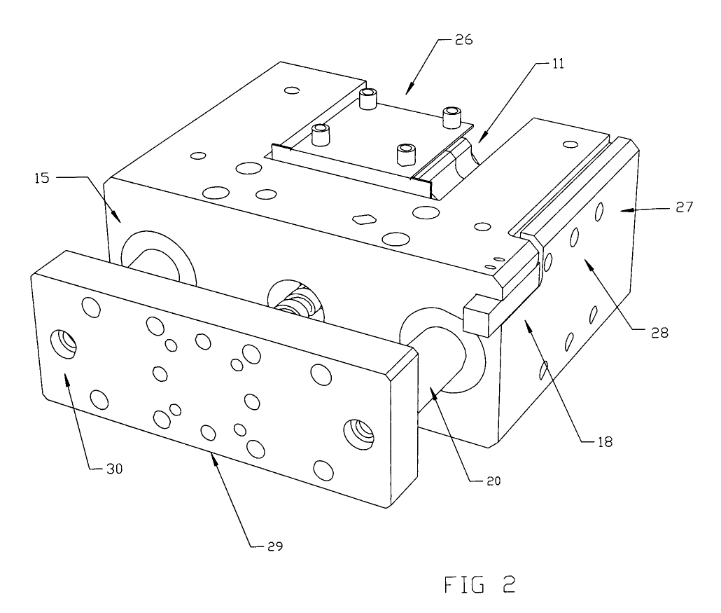

Turning now to FIG. 2 an assembled front perspective is shown. Note the in-line orientation of the drive/controller mount 26 with respect to the linear actuator 11. The drive/controller L bracket can be reversed such that the mount 26 is on the bottom of FIG. 2. The embedded proximity switch is shown mounted and set screwed into position at 18. As illustrated, the proximity switch is fully embedded such that the 4 ea drilled and tapped mounting pattern represented by 27 and 2 ea vertical dowels 28 can be used for mounting without interference with the proximity switch. On the face of the tooling plate there is shown a pattern of thru hole and drilled and tapped load mounting features as well as two vertical slip fit dowels 29. As discussed earlier, the shafts 20 are slip fit into the rear of the tooling plate with counter bore features 30 that embed the fasteners. Lastly the bearings 15 are fixed into the slide housing with adhesive and are flush with the face and rear of the slide housing.

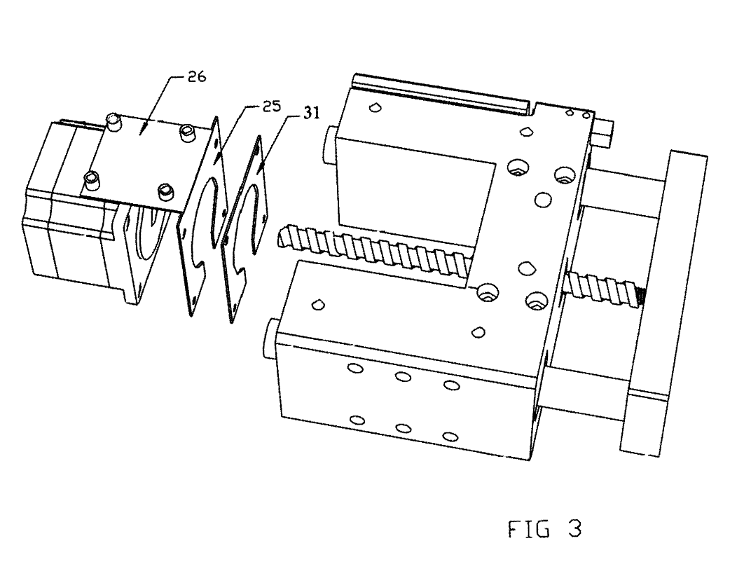

Turning now to FIG. 3, an exploded side view of the system illustrates the drive controls mounting features. On the surface engaging the linear actuator, 25, note the opening in the sheet metal. This slot allows the drive/controller L bracket to be attached or removed without unthreading the lead/ball screw. The molding rubber, silicon or engineered plastic dampening feature, 31, is shown, for clarity, detached from the mounting face 25.

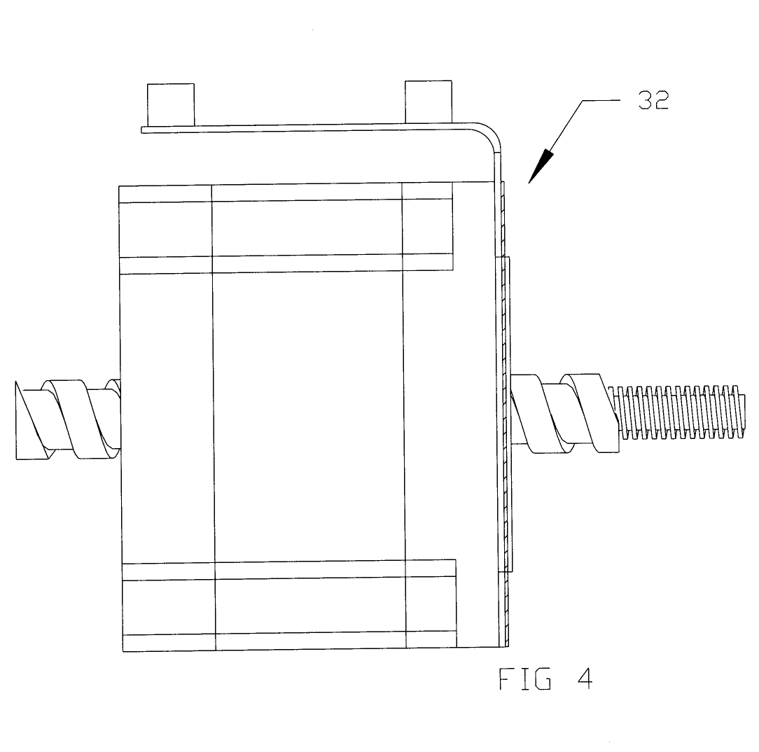

FIG. 4 illustrates the dampening material attached, bonded and/or molded 32 to the forward mounting face of the drive/controller mount.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A machine for positioning a tooling plate with an integrated linear actuator, comprising: a complete, integrated slide assembly which uses standard linear actuators; an integrated bearing, shafting and tooling plate system that requires no alignment or adjustments during installation and normal use:
An anodized bearing body and tooling plate with multiple drilled and tapped and counter sunk through hole mounting features with dowel slip fit holes for precision mounting and alignment.
A bearing body with mounting features that enable to the unit to be mounted on any of four precision machined surfaces allowing for maximum flexibility for harnessing runs to the integrated drive/controller mounting system.
A plane bearing and cantilevered shaft system that requires no lubrication or maintenance.
an embedded proximity switch for homing with a machined cable run protecting the cable during assembly and use.

2. A machine for positioning a tooling plate with an integrated linear actuator, as claimed in claim 1 further comprising: A integrated sheet metal mounting system for programmable drive/controllers that does not interfere with lead screw or tooling plate motion.
A integrated mounting system that allows the drive/controller to be replaced without replacing the actuator.
An integrated mounting system that allows encoders and antibacklash nuts to be mounted on the rear of the linear actuator without interference or assembly issues.

3. An integrated sheet metal mounting system, as claimed in claim 2, further comprising; A molded rubber, adhesive backed silicon or engineered plastic vibration dampening material attached to the mounting surface of the drive/controller mounting bracket.
